(19) United States
(12) Patent Application Publication
(10) Pub. No.: US 2010/0050147 A1
(43) Pub. Date: Feb. 25, 2010

(54) METHOD AND DEVICE PROVIDING INTEGRATED CIRCUIT DESIGN ASSISTANCE

(75) Inventors: Stephane Bonniol, Plaissan (FR); Michel Tabusse, Montpellier (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SATIN IP TECHNOLOGIES, Montpellier (FR)

(21) Appl. No.: 12/519,250

(22) PCT Filed: Dec. 13, 2007
(86) PCT No.: PCT/FR07/52499

§ 371 Date: Jun. 15, 2009

(30) Foreign Application Priority Data
Dec. 14, 2006 (FR) 0610893

(51) Int. Cl. G06F 17/50

(52) U.S. Cl. 716/17

(57) ABSTRACT

The invention relates to a method and device providing integrated circuit design assistance. Independently of a design flow, the inventive method comprises the following steps, namely: a step (405) in which an information abstraction layer (320) is put in place, using a set of classes (105 to 125) in order to create objects having a defined structure, said abstraction layer being independent of the design flow (305) of all or part of the integrated circuits; a step (445) in which specific data representative of the design flow are captured in order to assign values to the fields of at least part of the objects; and a step (450) in which the values of the objects are interpreted by design quality measurement and/or control applications. During the abstraction layer introduction step in certain embodiments of the invention, the abstraction layer has a dynamic structure in order to store the information required to measure and control the quality of reusable integrated circuit blocks. In other embodiments of the invention, the abstraction layer is based on two classes of objects with dynamic field lists, the first class enabling the creation of “category” objects which define formats and characteristics of the “information” objects from the second class.

This invention relates to a method and a device providing integrated circuit design assistance, independently from a design flow. It applies in particular to the electronic industry.

The design and integration flow of an IP block is by nature strongly heterogeneous and unstable. It is comprised of a large number of tools and methods for each implementation and verification phase, and is supplemented with specific and proprietary practices based on the experience of the various actors. The implementation of these tools and methods generates a set of data useful for measuring and controlling the quality. But the nature of these data, their format and their location are directly related to the tool and the method used. Their interpretation for deriving from same a quality parameter thus requires a specific knowledge of the tool and the method.

Generally speaking, because of the format specific to each design flow, the user of the latter is then obliged to manipulate almost manually the data resulting from said flow, in order to interpret them for deriving their adequateness for the expected level of quality.

Several methods and devices try to provide another type of assistance for the integrated circuit design, for example through grouping data relating to the IP blocks in the form of sharing a catalogue or a database, as described in U.S. Pat. No. 6,970,875. This solution allows using and combining existing blocks. Another solution consists for example in checking their characteristic, for example the processing time related to said block or to the combination of blocks achieved, as described in U.S. Pat. No. 5,581,473. However, these methods are not related to a setting up of a global control of the quality of heterogeneous design flows.

On the other hand, the quality parameters used for measuring and controlling the design and the integration of an IP block are universal (within the framework of the integrated circuit design) and are independent from the tools and methods used. For example an IP block designed within the framework of a flow A should be able to be used within the framework of a flow B. The intrinsic quality of an IP block should not depend on the means implemented to design it. It is nevertheless those means that will provide the indications on its quality. As regards the quality parameters, there exist actual standards, promoted by some organizations such as VSIA, but it is important to leave the door open for the definition of other parameters, if necessary.

There is thus a need for obtaining a homogeneous view of the quality of an IP block, through the various phases of its life cycle, but also a same view among various IP blocks, based on data provided by a very large variety of tools and methods, in one and the same design flow or among various design flows.

This view of the quality should be obtained thanks to a method allowing assisting the designer or user of the IP block in capturing the necessary information and in using this information for measuring and controlling the quality. The invention described herein allows setting up such a method for controlling the quality and coping with the drawbacks of the prior art.

To this end, according to a first aspect, this invention relates to a method for providing integrated circuit design assistance independently from a design flow, wherein the method includes:
a step of setting up an information abstraction layer implementing a set of classes for creating objects by defining their structure, the abstraction layer being independent from said design flow of all or part of the integrated circuits,
a step of capturing specific data representative of said design flow, for assigning values to fields of at least part of said objects, and
a step of interpretation of the values of said objects by applications for measuring and/or controlling the quality of the design.

This invention thus provides an object structure and a method permitting to collect, in a homogeneous and stable form, all the information necessary to measure and control the quality of all or part of an integrated circuit during the design and integration phases. This method thus permits to set up one single quality management dashboard for all the phases of the life cycle of all or part of an integrated circuit, in a highly heterogeneous and unstable environment. It should be noted that, since the abstraction layer is independent from the integrated circuit design flow, it provides a stable and homogeneous basis for measuring and controlling the quality.

According to particular features, during the step of setting up of the abstraction layer, the latter has a dynamic structure for storing the information necessary for measuring and controlling the quality of re-usable blocks of integrated circuits.

The implementation of this invention thus provides at least one management dashboard for measuring and controlling the design and integration quality of re-usable blocks of integrated circuits, also referred to as <<IP>> (acronym for <<Intellectual Property>>).

According to particular features, the method as succinctly set forth above includes a step of storing field names and their values in dynamic lists, of the categories of objects implemented in the abstraction layer. Furthermore, these categories are themselves dynamically created objects, and having dynamic lists for their characteristics.

The structures permitting to store the quality information can thus be defined according to the needs. They can in particular be programmed, created, modified through the user interface, without having to modify the source code of the application.

According to particular features, during the step of setting up of the abstraction layer, the latter is based on two object classes with dynamic lists of fields, the first class permitting to create <<category>> objects defining the formats and characteristics of the <<information>> objects, instance of the second class.

Thanks to its dynamic structure, the abstraction layer can be dynamically re-configured according to the needs.

According to particular features, the method as succinctly set forth above includes a step of dynamic modification of the menus of a graphical user interface for inputting and displaying the <<information>> objects. These menus are dynamically modified according to the new structure of the objects and are adapted to the latter.

Thus, the existing objects are dynamically updated according to the new structure: the obsolete fields are deleted and the new fields are eventually filled out at the next modification of the objects.

According to particular features, the method according to the invention includes a step of referencing <<information>> objects with respect to each other by link-type fields, the <<information>> objects having at least one field the value of which is obtained during a step of data capture.

According to particular features, this method includes a step of storing the <<category>> objects and the <<information>> objects in at least one relational database.

According to particular features, each said database includes, at least, one table <<CATEGORY>> for storing the <<category>> objects and one table <<CUSTOM>> for storing the <<information>> objects.

This method advantageously includes a step of creating a database for each project and/or for each integrated circuit block. The categories of <<information>> objects can thus be personalized project by project and the <<information>> objects are thus stored project by project.

According to particular features, the method includes a step of specification of at least one <<sensor>> object implemented during the step of data capture, for creating a bridge between the abstraction layer and the integrated circuit design flow.

According to particular features, the step of capturing is automatic, namely through assigning values to said object fields through a link to at least one <<sensor>> object.

Thus, measuring and controlling the quality of an IP block occur without hindering the design process, thanks to the automation of the capture of the necessary information, while preserving the integrity of the captured data. The automatic aspect of the data capture provides an objective measure at any time of the evolution of the design flow without interfering with the latter. This invention thus pretends to be a non-intrusive solution with respect to said flow.

According to particular features, this method includes a step of constructing a library of applications for measuring and/or controlling the quality. It should be noted that the implementation of this invention allows this library to be stable and standardized within an organization.

According to particular features, the step of interpreting the classes by applications for measuring and/or controlling the quality of the design is performed in random access memory in lists.

Thus, this step does not implement SQL requests on each database. The use of the SQL requests, requiring more resources, is thus preferably limited to the setting up of the lists for processing in the business layer. The applications based on the abstraction layer can thus handle a large number of objects (several tens of thousands) and the speed of execution is optimized.

According to a second aspect, this invention relates to a device for implementing said method, wherein the device includes:
means for setting up an information abstraction layer implementing a set of classes for creating objects by defining their structure, the abstraction layer being independent from said design flow of all or part of the integrated circuits,
means for capturing specific data representative of said design flow, in order to assign values to the fields of at least part of said objects, and
means for interpreting the values of said objects by applications for measuring and/or controlling the quality of the design.

Since the advantages, aims and features of this device are similar to those of the method as succinctly set forth above, they are not repeated here.

Further advantages, aims and features of this invention will become clear from the following description given by way of an explanation and being in no way restrictive, with reference to the attached drawings, wherein:

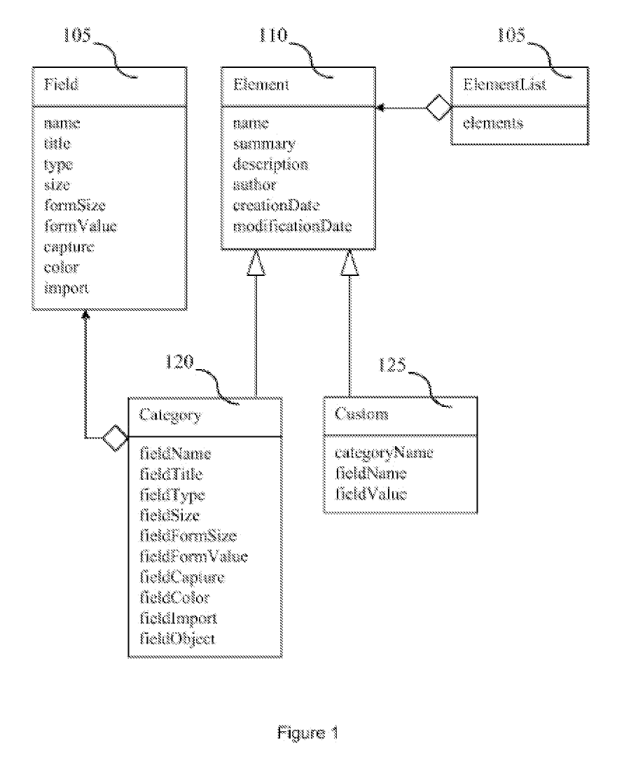

FIG. 1 schematically shows classes implemented by particular embodiments of the method object of this invention,

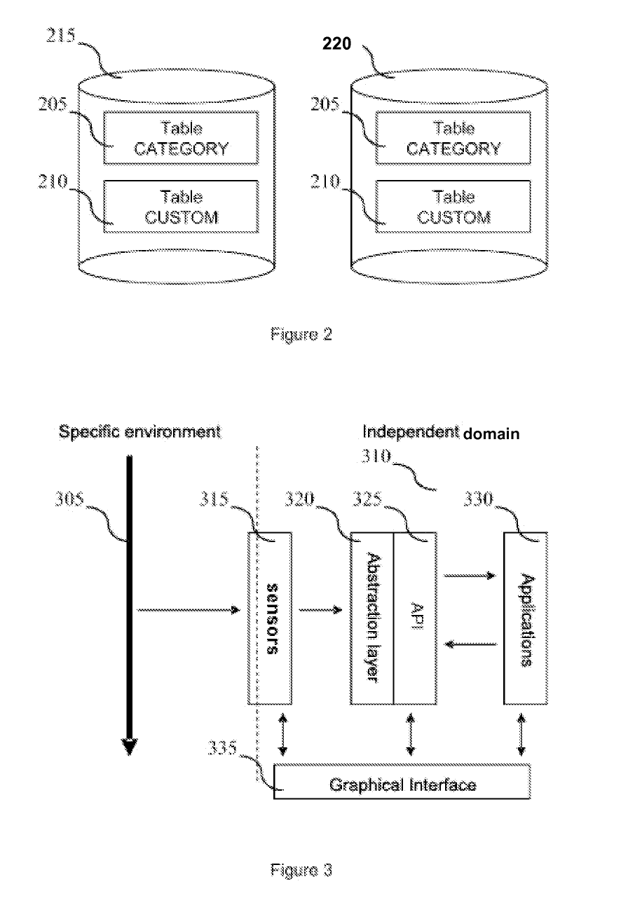

FIG. 2 schematically shows databases implemented by particular embodiments of the method object of this invention,

FIG. 3 shows interactions between a flow and software components implemented by particular embodiments of the method object of this invention,

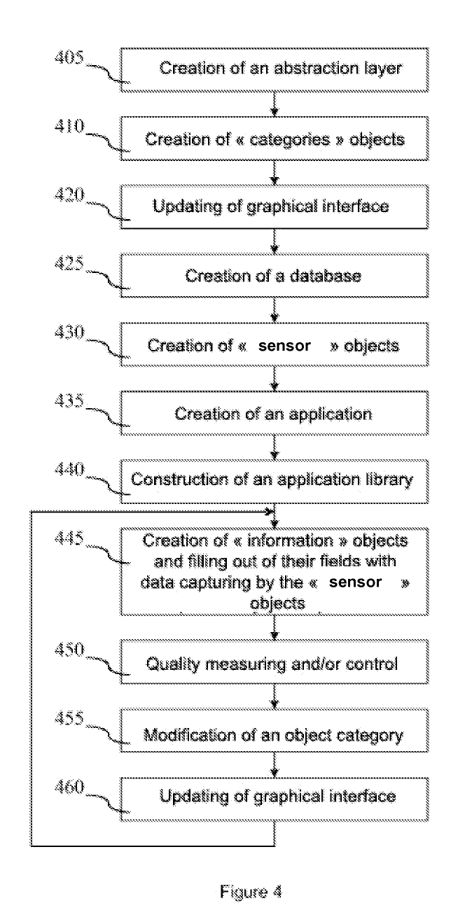

FIG. 4 shows, in the form of a logical diagram, steps implemented in particular embodiments of the method object of this invention, and

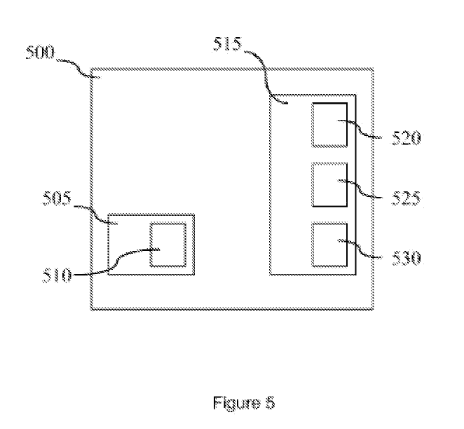

FIG. 5 schematically shows a particular embodiment of the device object of this invention.

As regards the abstraction layer (or level) implemented for implementing this invention, FIG. 1 shows a diagram of classes in which can be found:
a class 105 <<Field>>,
a class 110 <<Element>>,
a class 115 <<ElementList>>,
a class 120 <<Category>>, and
a class 125 <<Custom>>.

It should be noted that all information and data necessary for measuring and controlling the quality are stored, in classes 105 to 125, in the form of objects or object attributes.

Thus, class 105 <<Field>> includes the following fields, the detail of which is given hereinafter
<<name>>,
<<title>>,
<<type>>,
<<size>>,
<<formSize>>,
<<formValue>>,
<<capture>>,
<<color>>, and
<<import>>.

Class 110 <<Element>> includes the following fields
<<name>>,
<<summary>>,
<<description>>,
<<author>>,
<<creationDate>> and
<<modificationDate>>.

Class 115 <<ElementList>> includes the following object
<<Elements>>.

Class 120 <<Category>> includes the following fields
<<fieldName>>,
<<fieldTitle>>,
<<fieldType>>,
<<fieldSize>>,
<<fieldFormSize>>,
<<fieldFormValue>>,
<<fieldCapture>>,
<<fieldColor>>,
<<fieldlmport>>, and
<<fieldObject>>.

And class 125 <<Custom>> includes the following fields:
<<categoryName>>,
<<fieldName>>, and
<<fieldValue>>.

The objects pertain to a category (or type) of objects the structure of which is described above. A number of categories of objects are predefined, but their structure can be modified (list of attributes or fields) and new categories can be created, while preserving the integrity of the objects already created.

The structure of the objects is construed from two classes: class 120 <<Category>>, which permits to define the categories by a list of fields with their characteristics and a class 125 <<Custom>>, which permits to create <<information>> objects and to store the values of the fields according to their category. The categories are thus themselves objects instances of class 120 <<Category>> and the quality information is stored in objects instances of class 125 <<Custom>>. Classes 120 <<Category>> and 125 <<Custom>> inherit from the parent class 110 <<Element>>. All <<category>> objects and all <<information>> objects thus have the fields of this class: <<name>>, <<summary>>, <<description>>, <<author>>, <<creationDate>> and <<modificationDate>>.

The persistence of the <<category>> objects and the <<information>> objects is ensured by a layer of relational databases, shown in FIG. 2. In FIG. 2, two databases 215 and 220 are shown. Each database, 215 et 220, is comprised of two tables: table 205 <<CATEGORY>> and table 210 <<CUSTOM>>. The structure of the recordings in the tables is described hereinafter. A database is created per project and per IP block. The categories of <<information>> objects can thus be personalized project by project and the <<information>> objects are stored project by project.

It should be noted that the persistence of the objects can also be ensured by other means, for example XML files (acronym for <<eXtended Markup Language>>).

Class 120 <<CATEGORY>> permits to instantiate an object defining an information category. This object information <<category>> is then referenced when creating an <<information>> object by the field <<categoryName>> of class 125 <<CUSTOM>>. The definition of a category consists in specifying the list of the fields that will be filled out when creating the <<information>> object pertaining to this category, with their characteristics, for example graph, title, possible values, mapping, colors and order. The class <<CATEGORY>> includes a set of <<list>> type fields for specifying each field of the category. To a position in a list corresponds a characteristic of a field. The fields of the list type are as follows:
<<fieldName>>: Name of the field; must be unique for a given category,
<<fieldTitle>>: Title of the field; text appearing in the graphical interface for inputting or reading the field,
<<fieldType>>: Type of the field; which permits to define both the function of the field and the graphical mode used for its input; among the examples of types can be cited <<Title>>, <<Text>>, <<TextArea>>, <<Password>>, <<Path>>, <<FileUpload>>, <<Date>>, <<Select>>, <<Radio>>, <<LinkSingle>> and <<LinkMultiple>>. Further types can be added, the interpretation of the types being programmed by a graphical interface and corresponding applications,
<<fieldSize>>: Size of the field in memory, useful for the text types,
<<fieldFormSize>>: Size of the area of the field in the graphical input interface (form),
<<feldFormValue>>: Enumeration of the possible values for inputting the field by the graphical input interface (form). In the case of the type <<LinkSingle>>, link to another object, or the type <<LinkMultiple>>, link to other objects, enumeration of the categories that can be linked to this field of this category,
<<fieldCapture>>: Name of the category of the object used for automatically inputting the value of the field,
<<fieldColor>>: Color of the area of the field in the graphical interface, and
<<fieldlmport>>: Name of the corresponding mapping for importing <<information>> objects from an external source.

Class 120 <<CATEGORY>> also includes a field <<fieldObject>> of the type list of class objects <<Field>> permitting to directly access the characteristics of a field of the <<information>> object, during processing operations on this object by the graphical interface or by the applications. A field of the <<list>> type as above is used for transferring the categories to the database and when inputting the categories by the graphical interface.

Class 125 <<CUSTOM>> permits to instantiate an <<information>> object. The category of the object is specified by the field <<categoryName>>, the value of which corresponds to the name of a previously created <<category>> object, instance of the above-described class <<CATEGORY>>.

Class 125 <<CUSTOM>> includes two list-type fields, <<fieldName>> and <<fieldValue>> permitting to store, on the one hand, the names of the fields of the <<information>> object and, on the other hand, the corresponding values. Thus, at a given position is obtained, in the first list, the name of the field and, in the second list, the value corresponding to this field. The characteristics of the field are stored in the corresponding <<category>> object. The values of the fields are all stored in the form of a character string. The interpretation of the values of the fields in integer, real or other type is programmed in the corresponding applications. The cohesion of the automatically inputted or captured values is checked thanks to the type of the field specified in the corresponding <<category>> object.

The names of the fields and their values are stored in dynamic lists, the categories are themselves objects (hence created dynamically) having dynamic lists for their characteristics. The structures permitting to store the quality information can thus be programmed, created, modified according to the needs, through the user interface, without having to change the source code of the application. Thus, a structure of an object can be re-defined without intervening on the initial program, thus omitting an eventual hard coding.

The graphical menus for inputting and displaying the <<information>> objects are also modified dynamically according to the new structure. The existing objects are updated dynamically according to the new structure: the obsolete fields are deleted and the new fields are eventually filled out at the next modification of the objects (automatic synchronization of the lists <<fieldName>> and <<fieldValue>>).

On the other hand, the class <<CATEGORY>> can also evolve by adding new <<list>> fields to specify new characteristics for the fields of the <<information>> objects. The modification of the code of the class <<CATEGORY>> thus requires an update of the <<category>> objects instances of this class, whereby such a modification must occur during the re-installation of the application. On the other hand, all the <<information>> objects already existing in the database are preserved by such a modification, since the characteristics of their fields are not in class 125 <<CUSTOM>>. Thus, the application can be enriched by adding new characteristics for the fields of the <<information>> objects, without any impact on said <<information>> objects created by a previous version of the application.

As explained above, the persistence of the <<category>> and <<information>> objects occurs by storing the objects in a relational database. Each object is stored in the form of one single record in a table, <<CATEGORY>> or <<CUSTOM>>. The dynamic fields <<list>> are mapped, i.e. stored in a structured way, in <<TEXT>> type columns, the elements of the lists being separated by a programmable regular expression, for example the character ‘|’. A <<list>> type field is thus stored in the database in the form of a character string in a column, its various elements being separated by the chosen separator. The regular expression chosen must not appear in the values of the elements of the list. During a transfer of an object implying a database, a conversion is carried out between the <<list>> type fields of the object and the <<TEXT>> type columns of the record in the database.

Further mappings of the <<list>> type field can be contemplated. This choice permits to limit the use of the database to the simplest SQL instructions (acronym for <<Structured Query Language>>) to store, change or select the objects, the dynamic aspect of the structure of the objects being processed at the level of the classes and their <<list>> type fields. The particular embodiment of the method object of this invention does thus not rely on a complex organization of the objects in the database used by joining SQL instructions (see <<MatrixOne>> method, registered trademark), to separate the business layer from the persistence layer and to thus be able to easily chose other storage techniques, such as XML files. The architecture of the system can thus be optimized and secured according to the needs and in the event of breakdown, for example, by passing over to a storage in the form of XML files, should the SQL not be available.

In addition, the applications based on the abstraction layer can handle a large number of objects (several tens of thousands) and need to access to the various fields in an optimal way. In order to optimize the speed of execution, all these processing operations preferably occur in a random access memory in lists and not by SQL requests on the database. The use of the SQL requests is thus preferably limited to the constitution of lists for processing in the business layer.

The abstraction layer provides a simple API (acronym for <<Application Programming Interface>>). In object-oriented language, this is the set of public and documented methods of a class permitting to create objects of that class and to handle them. These are for example <<set>> and <<get>> methods permitting to read or write the various fields of the object referenced in the code of an application. In embodiments of this invention, this API is enriched in the course of time, so as to constitute a library of methods permitting to create new applications. An application can itself become a new method of the library if it proves useful, so as to be able to program new applications, for example:
search for objects according to their category and/or their name,
recovery of the value of a field of an object, and
creation, modification, deletion of object(s).

Class 115 <<ElementList>> is used for storing lists of objects selected for processing.

As regards the capture of information, all information and data necessary for measuring and controlling the quality are captured:
manually through a graphical interface, or GUI (acronym for <<Graphical User Interface>>), for example, for the data and remarks resulting from a human reflection, or
automatically, through execution of <<sensor>> objects for the measurable parameter values.

The graphical interface provides a set of menus for displaying and editing <<category>> and <<information>> objects. The format of the menus for the <<information>> objects is construed automatically from the characteristics described in the corresponding category. Through these menus, the objects and their fields can be specified manually.

Within the framework of the measurement and control of the quality of a process, it is essential that the collection of the necessary information occurs continuously and without hindering the process itself. In the case of the integrated circuit design, it is important to minimize the cost required for capturing the information, in order not to consume resources dedicated to the creation of the IP block, which would finally have a negative impact on the quality of the IP block. Since a large number of information useful for measuring and controlling the quality is generated by design tools and formal methods, in various forms, their capture in the above-described abstraction layer occurs automatically. The information can be available in text files, in databases or returned by a program call.

The method used for implementing the method object of this invention is based on software routines encapsulated in programmable <<sensor>> objects as described above. The fields of this category of objects permit to specify the regular expressions to be looked for in the files, the parameters of the link to databases, the program calls. These <<sensor>> objects are attached to fields of <<information>> objects in order to automatically import their value. The <<sensor>> objects are used for importing objects of a category using the mapping information for the correspondence of the fields. These <<sensor>> objects can thus be created, modified and stored, in order to build an automatic bridge between the specific and unstable elements of the design flows and the stable and homogeneous abstraction layer. Adapting a <<sensor>> object to a new situation occurs by modifying one or several fields of the corresponding object.

As regards the applications, the objects and the values of the fields of the automatically filled objects are interpreted by programs generating the quality views in various forms, for example tables, graphs, reports, metrics (set of measuring points the value of which permits to measure a quality or a tendency, for example the rate of bugs found per week) or standard media.

The independence of the abstraction layer with the specificities of the design flows permits to build a stable and standardized set of applications for measuring and controlling the quality within an organization.

The applications depend only on the format of the abstraction layer defined by the <<category>> objects. New applications can be developed using the API of the abstraction layer providing all the functions necessary for handling the objects.

FIG. 3 shows, on the one hand, the specific environment related to a flow 305 and, on the other hand, the independent domain 310. The latter includes sensors 315 related to the flow 305, an abstraction layer 320, an API 325, applications 330 and the graphical interface 335. The sensors form the interface between the flow 305 and the abstraction layer 320, making the latter independent from the flow 305.

FIG. 4 shows a particular embodiment of the method object of this invention for creating objects of the category <<FUNCTSPEC>>, functional specification, containing a field permitting to link this type of <<FUNCTSPEC>> objects to one or several objects of the category <<REQUIREMENT>>, expression of the needs for the design of an IP block, already defined, and of the category <<DOCUMENT>>, meta-information on the reference or standard documents used for the design, already defined, a field permitting to store the state of its manual review, and a field permitting to link this type of objects to an object of the category <<RELEASE>>, version of the IP block, already defined.

In a step 405 is created an abstraction layer, or level, with the classes 105 to 125 shown in FIG. 1. It should be noted that the abstraction layer provides a simple API, in order to be able to program new applications, for example:
search for objects according to their category, their name,
recovery of the value of a field of an object and creation, modification, deletion of object(s).

The abstraction layer of the information implements a set of object classes for creating objects by defining their structure, and is independent from the design flow of all or part of the integrated circuits. The abstraction layer has a dynamic structure for storing the information necessary for measuring and controlling the quality of blocks of re-usable integrated-circuits. The abstraction layer is based on two object classes with dynamic lists of fields, the first class permitting to create <<category>> objects defining the formats and characteristics of the <<information>> objects instances of the second class.

In a step 410 are created <<category>> objects defining a category (or type) of objects the structure of which is described above. It is recalled that a number of categories of objects are predefined and that their structure can be modified (list of attributes or fields) and that new categories can be created, preserving the integrity of the objects already created and of the previously captured and stored data. The structure of the objects is construed from two classes: class 120 <<CATEGORY>>, which permits to define the categories by means of a list of fields and their characteristics, and a class 125 <<CUSTOM>>, which permits to create “information>> objects and to store the values of the fields according to their category.

Class 120 <<CATEGORY>> permits to instantiate an object defining an information category. This information <<category>> object is then referenced during the creation of an <<information>> object by the field <<categoryName>> of class 125 <<CUSTOM>>. The definition of a category consists in specifying the list of fields that will be filled out during the creation of the <<information>> object pertaining to this category, with their characteristics, for example graph, title, possible values, mapping, colors and order.

Class 120 <<CATEGORY>> includes, in particular, the field <<fieldObject>> of the type list of class objects <<Field>> permitting to directly access the characteristics of a field of the <<information>> object, during processing operations on this object by the graphical interface or by the applications. A field of the above <<list>> type is used for the transfers of the categories to the database and during the input of the categories by the graphical interface.

Class 125 <<CUSTOM>> permits to instantiate an <<information>> object.

The names of the fields and their values are stored in dynamic lists, the categories are themselves objects (thus created dynamically) having dynamic lists for their characteristics. The structures permitting to store the quality information can thus be programmed, created, modified according to the needs, through the graphical interface, without having to modify the source code of the application.

Step 410 is in fact the creation of <<category>> objects in which one or several fields can be specified as a link to other <<information>> objects of a determined category. This link mechanism permits to specify a link-type field (<<LinkSingle>>, <<LinkMultiple>>).

In the example shown in FIG. 4, a <<category>> object is defined with the following values for the fields of the class <<CATEGORY>>, i.e. this object is created by a program or a new instance of the class <<CATEGORY>> has been created by specifying the values of the fields, the <<list>> type fields that permit to specify the characteristics of each field of the thus created category being input into a table through the graphical interface 335:
<<name>>: <<FUNCTSPEC>>, name permitting to reference the category for the <<information>> objects,
<<summary>>: category for the objects of functional specifications (free text for briefly presenting the nature of the object),
<<description>>: this <<category>> object includes the fields <<requirementName>>, <<manualReview>>, <<configuration>>. The field <<requirementName>> is used for . . . etc, (free text permitting to describe in detail the role of this object),
<<fieldName>>:
   |requirementName|manualReview|configuration| (names of the specific fields of the objects pertaining to this category, separated by the selected regular expression, in this case the character ‘|’),
<<fieldTitle>>: |RequirementName|Manual Review|Configuration| (titles of the specific fields used for displaying the objects and in the input forms),
<<fieldType>>: |LinkMultiple|Radio|LinkSingle| (types of the fields permitting to define their function and their graphical characteristics: the first one is a multiple link input from a selection list, the second one is a radio button, the third one is a single link input from a selection list,
<<fieldSize>>: |none|none|none| (the size of the memory must not be specified for these types of fields),
<<fieldFormSize>>: |none|none|none| (the size of the graphical areas must not be specified for these types of fields),
<<fieldFormValue>>: |REQUIREMENT,DOCUMENT|Yes,No|RELEASE| (for the first field, all the objects of the category REQUIREMENT and the category DOCUMENT, already defined, will be provided in the selection, for the second field, the values <<Yes>> and <<No>> will be provided on the radio button, for the third field, all the objects of the category RELEASE, already defined, will be provided in the selection),
<<fieldCapture>>: |none|none|none| (none of these fields is captured automatically),
<<fieldColor>>|SILVER|BISQUE|SILVER| (colors for the second field in the graphical interface), and
<<fieldlmport>>|requirementName|manualReview|configuration| (correspondence of names for mapping in case of automatic import of the objects of this category).

In a step 420, a user interface is updated, the graphical menus of which for inputting and displaying the <<information>> objects are also dynamically modified according to the new structure. The existing objects are dynamically updated according to the new structure: the obsolete fields are deleted and the new fields are eventually filled out at the next modification of the objects (automatic synchronization of the lists <<fieldName>> and <<fieldValue>>).

This graphical interface provides a set of menus for displaying and editing <<category>> and <<information>> objects. The format of the menus for the <<information>> objects is construed automatically from the characteristics described in the corresponding category. Through these menus, the objects and their fields can be specified manually.

In the example shown in FIG. 4, once each <<category>> object has been created, the graphical interface has all the necessary characteristics for automatically providing all the menus for editing the <<information>> objects of the category <<FUNCTSPEC>>, instances of the class <<CUSTOM>>.

In a step 425, a relational database is created for ensuring the persistence of the <<category>> objects and the <<information>> objects, comprised of two tables: table 205 <<CATEGORY>> and table 210 <<CUSTOM>>. The structure of the records in the tables is described above. The <<category>> objects and the <<information>> objects are thus stored in a relational database.

A database is preferably created for each project and/or for each integrated-circuit block. Each database includes at least a table <<CATEGORY>> for storing the <<category>> objects and a table <<CUSTOM>> for storing the <<information>> objects.

In a step 430, <<sensor>> objects are created, which perform the automatic capture of the information, i.e. of the information and data necessary for measuring and controlling the quality. The specification of at least one <<sensor>> object creates a bridge between the abstraction layer and the integrated-circuit design flow.

In order for the collection of the necessary information to occur continuously and without hindering the process itself, in the case of the integrated-circuit design, the cost required for capturing the information is minimized, in order not to consume resources dedicated to creating the IP block, which would finally have a negative impact on the quality of the IP block. Since a large number of information useful for measuring and controlling the quality is generated by design tools and formal methods, in various forms, their capture in the previously described abstraction layer occurs automatically. The information can be available in the design flow within text files, in databases or returned by a program call.

This is based on software routines encapsulated in programmable <<sensor>> objects, as described above. The fields of this category of objects permit to specify the regular expressions to be looked for in the files, the parameters of link to the databases, the program calls. These <<sensor>> objects are attached to fields of <<information>> objects for automatically importing their value. The <<sensor>> objects are used for importing objects of a category using the mapping information for the correspondence of the fields. These <<sensor>> objects can thus be created, modified and stored, in order to build an automatic bridge between the specific and unstable elements of the design flows and the stable and homogeneous abstraction layer. Adapting a <<sensor>> object to a new situation occurs by modifying one or several fields of the corresponding object. The users can thus re-configure the parameters for capturing such a <<sensor>> object.

In a step 435, the creation of at least one application, developed using the API of the abstraction layer is carried out, for accessing the <<information>> objects of the category <<FUNCTSPEC>> and to the values of the various fields of these objects: <<name>>, <<summary>>, <<description>>, <<requirementName>>, <<manualReview>>, <<configuration>>, <<author>>, <<creationDate>> and <<modificationDate>>. The functions of the API also permit to access the <<category>> object <<FUNCTSPEC>> and the values of its various fields. The characteristics of each field can be obtained directly using the list of the object <<Field fieldObject>> of the <<category>> object <<FUNCTSPEC>>.

An application checks, for example, whether the needs are met (category <<REQUIREMENT>>) by the functional specifications and shows the eventual lacks.

In a step 440, the construction of a library of applications for measuring and/or controlling the quality is carried out.

In another step 445, <<information>> objects are created, which each refer to a <<category>> object, then the <<sensor>> objects perform an automatic capture of values stored in the fields of <<information>> objects, through a link with at least one <<sensor>> object.

A referencing of the <<information>> objects, with respect to each other, occurs in step 445, as these <<information>> objects are created during the capture. The data capture indeed consists in creating the <<information>> objects and in filling out their fields (manually or automatically), the link occurring effectively during the creation of the <<information>> objects in step 445. In another step 450 is carried out the processing of the objects by applications for measuring and/or controlling the quality of the design.

It should be noted that the applications based on the abstraction layer can handle a large number of objects (several tens of thousands) and need to optimally access the various fields. In order to optimize the speed of execution, all these processing operations preferably occur in a random access memory, for example of the RAM type, in lists and not by SQL requests on the database. The use of the SQL requests is thus preferably limited to the constitution of the lists for processing in the business layer.

As regards the applications, the objects and the fields of the captured objects are interpreted by programs generating the quality views in various forms, for example, tables, graphs, reports, metrics or standard media.

The independence of the abstraction layer from the specificities of the design flows permits to build a stable and standardized set of applications for measuring and controlling the quality within an organization.

The applications depend only on the format of the abstraction layer defined by the <<category>> objects. New applications can be developed using the API of the abstraction layer providing all the necessary functions for handling the objects.

In an optional step 455, a dynamic modification of at least one category of objects is carried out, without modification or re-compilation of the application and preserving the integrity of all the existing information objects. For example, the storing of the names of the fields and their values in dynamic lists is carried out, the categories being themselves objects, thus being creating dynamically, having dynamic lists for their characteristics.

In another step 460 generated by the optional step 455, an automatic update of a graphical interface is performed, without modification or re-compilation of the application. For example, the dynamic modification of menus of a graphical interface for inputting and displaying <<information>> objects is carried out, these menus being modified dynamically according to the new structure. Then, one returns to step 445.

One observes, in FIG. 5, a computer 500 including a controller 505 provided with a random access memory 510 and a non-volatile memory 515 keeping a software 520 implementing the method object of this invention, at least one relational database 525 and an application 530 for measuring and/or controlling the quality of the design.

The computer 500 constitutes a device for implementing the method according to the invention. Such a device includes:
means (505, 405) for implementing an information abstraction layer (320) implementing a set of classes (105 à 125) for creating objects by defining their structure, the abstraction layer being independent from said design flow (305) of all or part of the integrated circuits,
means (505, 520, 445) for capturing specific data representative of said design flow, for assigning values to fields of at least part of said objects, and
means (505, 530, 450) for interpreting the values of said objects by applications for measuring and/or controlling the quality of the design.

When reading the preceding description of the method and the device objects of this invention, one understands that they permit to set up an abstraction layer with a dynamic structure for storing the information necessary for measuring and controlling the quality of blocks of re-usable integrated-circuits, based on two object classes with dynamic lists of fields. The first class permits to create <<category>> objects defining the formats and characteristics of the <<information>> objects instances of the second class. The abstraction layer is independent from the design flow of an IP block and provides a stable and homogeneous base for measuring and controlling the quality. Thanks to its dynamic structure, it can be dynamically re-configured according to the needs.

The implementation of this invention permits to dynamically modify the categories of objects, without modification or re-compilation of the application and preserving the integrity of all the existing information objects.

The implementation of this invention also permits to dynamically modify the categories of objects with automatic updating of the graphical interface, without modification or re-compilation of the application.

The implementation of this invention also permits to reference the <<information>> objects with respect to each other by link-type fields. It permits to specify <<sensor>> objects for creating a dynamic bridge between the abstraction layer and the sources of information, to automatically capture the values of the fields through a link to <<sensor>> objects, to build a library of applications for measuring and controlling the quality, stable and standardized within an organization.

The implementation of this invention permits to measure and control the quality of an IP block without hindering the design process: automation of the capture of the necessary information while preserving the integrity of the data.

It should be noted that this invention can be extended to fields other than the design of IP blocks, to all applications in which information should be collected and used through an abstraction layer permitting to de-correlate the measurement of the specificities of the environment.

1. Method for providing integrated circuit design assistance independently from a design flow, wherein the method includes:
a step of setting up an information abstraction layer implementing a set of classes for creating objects by defining their structure, the abstraction layer being independent from said design flow of all or part of the integrated circuits,
a step of capturing specific data representative of said design flow, for assigning values to fields of at least part of said objects, and
a step of interpretation of the values of said objects through applications for measuring and/or controlling the quality of the design.

2. Method according to claim 1, wherein, in the step of setting up of the abstraction layer, the abstraction layer has a dynamic structure for storing the information necessary for measuring and controlling the quality of blocks of re-usable integrated circuits.

3. Method according to claim 1, wherein the method includes a step of storing names of fields and their values in dynamic lists, for the categories of objects implemented in the abstraction layer being themselves objects having dynamic lists for their characteristics.

4. Method according to claim 1, wherein, in the step of setting up of the abstraction layer, the latter is based on two object classes with dynamic lists of fields, the first class permitting to create <<category> objects defining the formats and characteristics of the <<information>> objects instances of the second class.

5. Method according to claim 4, wherein the method includes a step of dynamically modifying menus of a graphical interface for the input and display of <<information>> objects, these menus being modified dynamically according to the new structure of the objects.

6. Method according to claim 4, wherein the method includes a step of referencing <<information>> objects with respect to each other by link-type fields, the <<information>> objects having at least one field the value of which is obtained during the step of data capture.

7. Method according to claim 4, wherein the method includes a step of storing <<category>> objects and <<information>> objects in at least one relational database including at least one table for storing the <<category>> objects and one table for storing the <<information>> objects.

8. Method according to claim 7, wherein the method includes a step of creating a database for each project and/or for each integrated circuit block.

9. Method according to claim 1, wherein the method includes a step of specifying at least one <<sensor>> object used in the step of data capture, for creating a bridge between the abstraction layer and the integrated circuit design flow.

10. Method according to claim 1, wherein the step of capturing is automatic, namely through the assignment of values to said fields of the objects by a link to at least one <<sensor>> object.

11. Method according to claim 1, wherein the method includes a step of constructing a library of said applications for measuring and/or controlling the quality.

12. Method according to claim 1, wherein the step of interpreting the classes by applications for measuring and/or controlling the design quality is carried out in random access memory in lists.

13. Device for implementing the method according to claim 1, wherein the device includes:
means for setting up an information abstraction layer implementing a set of classes for creating objects by defining their structure, the abstraction layer being independent from said design flow of all or part of the integrated circuits,
means for capturing specific data representative of said design flow, for assigning values to fields of at least part of said objects, and
means for interpreting the values of said objects by applications for measuring and/or controlling the quality of the design.
